(19) United States
(12) Patent Application Publication
(10) Pub. No.: US 2002/0188676 A1
(43) Pub. Date: Dec. 12, 2002

(54) Data server, data distribution program, computer-readable record medium bearing data distribution program, and client apparatus

(76) Inventors: Fujiko Iai, Yamatokoriyama-shi (JP); Katsuya Nakagawa, Soraku-gun (JP); Michita Katayama, Osaka (JP)

Correspondence Address: HARNESS, DICKEY & PIERCE, P.L.C., P.O. BOX 8910, RESTON, VA, 20195, US

(21) Appl. No.: 10/146,917

(22) Filed: May 17, 2002

(30) Foreign Application Priority Data
May 18, 2001 (JP) 2001-149864
Apr. 25, 2002 (JP) 2002-124696

(51) Int. Cl. G06F 15/16

(52) U.S. Cl. 709/203

(57) ABSTRACT

A data server includes a client data management unit for managing data stored in each client apparatus, a server data storage unit for storing the data in each client apparatus, a distribution data storage unit for storing distribution data sent from an information provider, a related data extraction unit for extracting the distribution data related to the data stored in the server data storage unit, and a communication unit connected to a network for performing communications with each client apparatus and the information provider. Information useful for a user is extracted on the data server side so that increase in traffic is prevented, and a load on the client apparatus is reduced.

The present application hereby claims priority under 35 U.S.C. §119 on Japanese patent publication numbers 2001-149864 filed May 18, 2001 and 2002-124696 filed Apr. 25, 2002, the entire contents of each of which are hereby incorporated by reference.

1. Field of the Invention

The present invention relates to a data server, a data distribution program and a computer-readable record medium bearing the program, and particularly to a data server, which can appropriately distribute data useful for users over a network, as well as a data distribution program and a computer-readable record medium bearing the program.

2. Description of the Background Art

Japanese Patent Laying-Open Nos. 9-269923 and 2000-101747 have disclosed systems for distributing predetermined information from a server to client apparatuses over a network.

In the system disclosed in Japanese Patent Laying-Open No. 9-269923, classified information items and advertisements are stored in a database of the server, and the client apparatus appropriately performs communications with the server for receiving information such as information items and advertisements in the database. Thereby, a display device displays information matching with profile data (matters of interest), which is set in advance by the user, during an idling period.

Japanese Patent Laying-Open No. 2000-101747 has disclosed a technology relating to a pager (i.e., client apparatus) having a schedule managing function. An information provider, which may also be referred to as an “IP” hereinafter, collects information, and an information processing provider processes various items of information thus collected into sending formats employed by a service provider or company. The processed data is sent to pagers.

The pager has the schedule managing function, and can save and manage the usual schedule data and regional information as well as information items (weather forecast, map, traffic information, event information and/or news) to be saved while establishing a correlation therewith when these are entered by the user. The pager extracts the information, which matches with the information items entered by the user, from various kinds of received information, and the extracted information is save and managed for display together with the schedule data.

By displaying the user's schedule together with the related information, it is possible to provide information matching with specific matters of user's interest.

However, the prior arts described above suffer from the following problems.

In the system disclosed in Japanese Patent Laying-Open No. 9-269923, the server sends all the information and all the advertisements to the client apparatuses, and data to be displayed is selected on the client apparatus side. Therefore, the client apparatus, of which hardware is usually restricted to a large extent, must extract the related data from a large amount of data, resulting in large loads. Therefore, the extraction processing requires a long time and large power consumption. In the battery-powered apparatus, charging or replacement of a battery is required frequently.

The data extraction is performed based on the profile data (classified favorite matters), which is registered in advance by the user. Therefore, extraction of the data can be performed only roughly, and cannot be performed based on specific matters.

Since all the information is simply sent to the client apparatuses, specific service cannot be sufficiently achieved, for example, by selecting specific users for providing service for a limited number of items or the like.

Further, traffic on a network increases because a large amount of data is sent.

According to the pager in Japanese Patent Laying-Open No. 2000-101747, when information to be saved in association with the schedule is sent from an information provider, the information is saved while establishing a correlation with the schedule. Therefore, the user must register a regional attribute, content attribute and information service transfer items when registering the schedule data (data and time, and contents). Thus, the user must state the kinds of related information to be provided to the user when the user registers the schedule. This takes time.

Further, only the related information thus stated is saved, and unexpected useful information cannot be provided to the user.

### SUMMARY OF THE INVENTION

An object of the invention is to provide a data server, which can suppress increase in traffic on a network, and can appropriately provide data useful for a user without imposing a load on a client apparatus, as well as a client apparatus for receiving data from the data server, a data transmission program and a computer-readable record medium bearing the program.

According to an aspect of the invention, a data server includes an obtaining unit for obtaining predetermined data stored in a client apparatus, a first storage unit for storing the predetermined data obtained by the obtaining unit and information of the client apparatus utilizing the predetermined data while establishing a correlation between the predetermined data and the information of the client apparatus, a second storage unit for storing distribution data, an extraction unit for extracting the distribution data related to the predetermined data stored in the first storage unit from the second storage unit, and a distributing unit for distributing the extracted distribution data to the client apparatus utilizing the predetermined data.

According to the invention, the predetermined data stored in the client apparatus is obtained, and is stored together with the information of the client apparatus utilizing the predetermined data while establishing a correlation therebetween. Therefore, matters of user's interest can be determined based on the predetermined data. Since the client apparatus utilizing the predetermined data is stored while establishing a correlation therebetween, a destination of the distribution data can be easily determined.

The distribution data related to the predetermined data is extracted, and is distributed to the client apparatus utilizing the predetermined data thus extracted. The distribution data related to the predetermined data is extracted, e.g., by keyword matching. Therefore, only the appropriate data related to the matters of user's interest is distributed to the target client apparatus.

Since the appropriate distribution data to be distributed is extracted in the data server as described above, it is merely required to receive the distribution data on the client apparatus side. Accordingly, a load on the client apparatus is reduced, and the data distribution service can be performed even if a hardware performance of the client apparatus is low. Further, traffic on a network does not increase.

Accordingly, it is possible to provide the data server, which can suppress increase in traffic on the network, and can provide data useful for the user without imposing a load on the client apparatus.

Preferably, the data server further includes a registering unit for registering the extracted distribution data in the first storage unit while establishing a correlation with the predetermined data.

According to this aspect, the extracted distribution data is stored while establishing a correlation with the predetermined data. Therefore, the distribution data related to the predetermined data can be appropriately managed.

Preferably, the data server further includes a management unit for managing client data stored in the client apparatus storing the predetermined data, and the management unit sends the predetermined data already updated and the extracted distribution data to the client apparatus utilizing the predetermined data when the predetermined data stored in the first storage unit is updated.

According to the above structure, the client apparatus manages the currently stored client data. When the predetermined data stored in the first storage unit is updated, the predetermined data thus updated is sent to the target client apparatus. For example, when the predetermined data is changed in any one of the plurality of client apparatuses sharing the predetermined data, the data in the other apparatuses is automatically updated. Further, each client apparatus is not required to employ a mechanism for the management because the management is performed by the data server.

The client data is data produced in the client apparatus, e.g., by operations of a user, and the predetermined data in the data server substantially serves as master data with respect to client data. Backup data of the client data may be the predetermined data of the data server. The client data may be information allowing reference to the predetermined data stored in the first storage unit of the data server. In this case, the predetermined data in the data server is master data, and the client data is, e.g., an ID and a reference address of the master data.

However, the client data produced by the client apparatus is usually and initially present only in the client apparatus, and the corresponding predetermined data is present after the client data is copied to the data server.

The client apparatus and the data server may perform a communication over a network, which is specifically formed of a wide-area network such as Internet, a local network using Ethernet (R), or another wired or wireless communication path using infrared rays, BlueTooth or RS232C. The data server may be achieved by a mainframe computer or a workstation on a wide-area network, or may be achieved by a personal computer. The client apparatus may be a personal computer, or may be a personal digital assistant (PDA), cellular phone or the like.

Preferably, the management unit further manages a correlation between the client apparatus and a user.

By adding the function of managing the correlation between the client apparatus and the user, unnecessary repeat or lack of distribution of the distribution data can be avoided even in such cases that one user has two or more client apparatuses, or that one client apparatus is shared by two or more users.

Preferably, the distribution unit distributes the extracted distribution data by means of an electronic mail. Since the distribution data is distributed by means of an electronic mail system, which is an existing technology, the data can be easily distributed to a specific client apparatus.

Preferably, the distribution data extracted by the extraction unit includes an electronic coupon. Thereby, the electronic coupons can be effectively distributed as the distribution data.

Preferably, the data server further includes a selecting unit for selecting the client apparatus as a target receiver of the distribution data extracted by the extraction unit. The distribution unit distributes the extracted distribution data to the selected client apparatus.

According to this structure, the client apparatuses can be appropriately selected as the target receivers of the distribution data, e.g., by a lottery so that the target receivers can be restricted in accordance with an intention of the provider of the distribution data.

Preferably, the distribution unit distributes the distribution data together with confirmation operation information for confirming a service, and the data server further includes a receiver unit for receiving results of the confirmation operation from the client apparatus receiving the confirmation operation information, and a providing unit for providing a service in accordance with the received confirmation operation results.

According to the invention, the results of the confirmation operation for confirming the necessity or nonnecessity of a service are received, and the service is provided in accordance with the results. Accordingly, the user's intention relating to the service is reflected so that the service can be provided more appropriately.

Preferably, the received confirmation operation results include attribute information. Thereby, an intention of the user can be reflected more specifically.

Preferably, the data server further includes an obtaining unit for obtaining information related to matters of user's interest, and the extraction unit narrows an extraction range of the distribution data based on the obtained matters of user's interest.

Since the extraction range of the distribution data is narrowed based on the matters of user's interest, only the distribution data close to the matters of user's interest can be distributed to the user.

Preferably, the data server further includes a receiving unit for receiving reference prohibition information for prohibiting reference to the data sent from the client apparatus by the distribution service (related data extraction unit).

Thereby, the data including the confidential contents of the user is not externally exposed if the related data thereof is not required.

Preferably, the data server further includes a control unit for controlling a time zone for distributing the distribution data by the distribution unit. Thereby, the data distribution can be appropriately performed in a time zone of low charges.

Preferably, the distribution data includes validity period information. The distribution unit further distributes the validity period information. Thereby, the data having an unexpired validity period can be displayed or output. Also, such a situation can be prevented that the meaningless distribution data having an expired validity period is present.

Preferably, the data server further includes a receiving unit for receiving information for starting or stopping the distribution of the distribution data from the client apparatus, and the distribution unit is controlled based on the received information for starting or stopping the distribution.

Thereby, reception and non-reception of the distribution data by each of the client apparatuses is determined independently of the other client apparatuses. Therefore, reception and non-reception of the distribution data can be selected for user's reasons.

Preferably, the data server further includes a providing unit for providing information concerning with the user or predetermined data to the distribution data provider. Thereby, the market information related to the distribution data can be provided to the distribution data provider.

Preferably, the providing unit provides the information concerning with the user or the predetermined data to the distribution data provider after processing the information concerning with the user or the predetermined data. For example, statistical data or the like can be processed into an easy-to-understand form, and private information of the user is processed into a form not allowing disclosure. Thus, the data can be provided in an appropriate form or state.

According to another aspect of the invention, a data distribution program operates a computer to execute an obtaining step of obtaining predetermined data stored in a client apparatus; a first storage step of storing the predetermined data obtained in the above step and information of the client apparatus utilizing the predetermined data while establishing a correlation between the data and the information; a second storage step of storing distribution data; an extraction step of extracting the distribution data related to the predetermined data stored in the first storage unit from the second storage unit; and a distribution step of distributing the extracted distribution data to the client apparatus utilizing the predetermined data.

According to the above program, the predetermined data stored in the client apparatus is obtained, and is stored together with the information of the client apparatus utilizing the obtained data while establishing a correlation therebetween. Therefore, it is possible to determine matters of the user's interest based on the predetermined data. Since the client apparatus utilizing the predetermined data is stored while establishing a correlation, the destination of the distribution data can be easily determined.

The distribution data related to the predetermined data is extracted, and is distributed to the client apparatus utilizing the predetermined data thus extracted. The distribution data related to the predetermined data is extracted, e.g., by keyword matching. Therefore, only the appropriate data related to the matters of user's interest is distributed to the target client apparatus.

Since the appropriate distribution data to be distributed is extracted in the data server as described above, it is merely required to receive the distribution data on the client apparatus side. Accordingly, a load on the client apparatus is reduced, and the data distribution service can be performed even if a hardware performance of the client apparatus is low. Further, traffic on a network does not increase.

Accordingly, it is possible to provide the data distribution program, which can suppress increase in traffic on the network, and can provide data useful for the user without imposing a load on the client apparatus.

According to still another aspect of the invention, a computer-readable record medium stores a data distribution program for operating a computer to execute an obtaining step of obtaining predetermined data stored in a client apparatus; a first storage step of storing the predetermined data obtained in the above step and information of the client apparatus utilizing the predetermined data while establishing a correlation between the data and the information; a second storage step of storing distribution data; an extraction step of extracting the distribution data related to the predetermined data stored in the first storage unit from the second storage unit; and a distribution step of distributing the extracted distribution data to the client apparatus utilizing the predetermined data.

Accordingly, it is possible to provide the computer-readable record medium bearing the data distribution program, which can suppress increase in traffic on the network, and can provide data useful for the user without imposing a load on the client apparatus.

According to yet another aspect of the invention, a client apparatus includes a storage unit for storing predetermined data to be managed in a data server; a receiving unit for receiving the data from the data server; an updating unit for updating the data in the storage unit to updated data when the received data includes the updated data for the predetermined data; a registering unit for registering related data related to the predetermined data already stored or updated in the storage unit when the received data includes the related data; and a recognizing unit for achieving recognition of the related data registered in the registering unit by a user.

According to the above apparatus, when the data received from the data server includes the updated data for the predetermined data, the predetermined data stored in the storage unit is updated to the updated data. Therefore, the predetermined data stored in the storage unit is appropriately updated without requiring input by the user or the like when the updating is required.

When the data received from the data server includes the related data related to the predetermined data or the predetermined data that is updated, the related data is registered, and is displayed or appropriately output so that the user can recognize it. Accordingly, the information including a matter of user's interest is appropriately received, and the user can recognize it.

Accordingly, it is possible to provide the client apparatus, which can appropriately receive the data useful for the user.

Preferably, the received data includes correlation information with respect to the predetermined data, and the registering unit registers the related data while establishing a correlation with the predetermined data.

Preferably, the received data includes an electronic coupon.

Preferably, the client apparatus further includes an output unit for performing output urging a confirmation operation, and an input unit for performing input of the confirmation operation, when the received data includes confirmation operation information for confirming a service.

Preferably, the client apparatus further includes a second output unit for performing output urging a confirmation operation and attribute input, and a second input unit for performing the confirmation operation and the attribute input.

Preferably, the client apparatus further includes a setting unit for setting a matter of user's interest, and a sending unit for sending the matter of interest set in the data server.

Preferably, the client apparatus further includes a second selecting unit for allowing selection of a time zone of data distribution by the user, and a notifying unit for notifying the selected time zone to the data server.

Preferably, the client apparatus further includes a managing unit for managing information of a validity period added to the related data.

Preferably, the data processing apparatus further includes a display unit for displaying the related data related to the predetermined data when the predetermined data is output.

Preferably, the client apparatus further includes a second display unit for displaying a list of the related data received by the client apparatus.

Preferably, the client apparatus further includes a third selecting unit for allowing selection of display and non-display of the related data by the user.

Preferably, the client apparatus further includes a fourth selecting unit for allowing selection of distribution and non-distribution of the related data by the user, and stop or start of distribution of the related data is instructed in accordance with results of the selection.

Preferably, the client apparatus further includes a fifth selecting unit for allowing selection of prohibition and allowance of reference to the data from a distribution service by the user, and prohibition or allowance of the reference from the distribution service is instructed based on results of the selection.

According to the invention, since extraction of the distribution data for advertisements or the like to be distributed to the client apparatus is performed in the data server, it is possible to suppress traffic on a network for the data distribution. Since data server performs the processing of extracting the related data from a large amount of data, which cause large loads, management and display of the distribution data can be performed even by the client apparatus, of which hardware is restricted to a large extent.

As another advantage of the invention, it is possible to provide the distribution data, which is close to a matter of user's interest and is not expected by the user, without requiring a special input of a profile, information relating to favorites, an information service item for each data, because the related data is automatically extracted from the server data such as a schedule usually used by the user.

As yet another advantage of the invention, the data server can perform detailed or specific service such as provision of special service using a limited number of items to selected specific users, because the data server performs management of the users or client apparatuses.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram showing a structure of a data server 10 in an embodiment of the invention;

FIG. 2 is a functional block diagram showing a structure of a client apparatus 20 in the embodiment of the invention;

FIG. 3 represents an example of a storage format of server data in a storage unit 13 for server data;

FIG. 4 is a flowchart representing a flow of processing of extracting distribution data (related data) related to the server data;

FIG. 5 is a flowchart representing a flow of processing for sending the related data to client apparatus 20;

FIG. 6 is a flowchart representing a flow of a whole operation of client apparatus 20 in the first embodiment;

FIG. 7 shows an example of display of related data on an output unit 23 of client apparatus 20 together with main data;

FIG. 8 shows an example of display of a list of only related data on output unit 23 of client apparatus 20;

FIG. 9 is a flowchart representing a flow of whole processing of data server 10 in a second embodiment;

FIG. 10 shows an example of display by client apparatus 20 for notifying a result of a lottery;

FIGS. 11A and 11B represent an example of a storage format of server data including confirmation operation data in storage unit 13 for server data;

FIGS. 12A and 12B show an example of display relating to confirmation operation on output unit 23 of client apparatus 20;

FIGS. 13A and 13B show an example of display relating to confirmation operation for data accompanied with attribute data on output unit 23 of client apparatus 20;

FIGS. 14A and 14B show an example of display relating to lottery result notification and confirmation operation data on output unit 23 of client apparatus 20;

FIG. 15 shows an example of a manner of displaying ON/OFF of a related data distribution server for each main data unit on output unit 23 of client apparatus 20 together with input main data;

FIG. 16 shows an example of a manner of displaying ON/OFF of a related data distribution server for each of a category and an attribute of main data on output unit 23 of client apparatus 20;

FIG. 17 shows an example of a storage format of server data including reference-prohibiting data for data in storage unit for server data; and

FIG. 18 is a flowchart representing a flow of processing of extracting distribution data (related data) related only to reference-allowing data based on the reference-prohibiting data of the server data.

### DESCRIPTION OF THE PREFERRED EMBODIMENTS

Embodiments of the invention will now be described in greater detail. In the following description, the same parts and portions bear the same reference numbers and the sane names, and have the same functions. Therefore, description thereof is not repeated.

[First Embodiment]

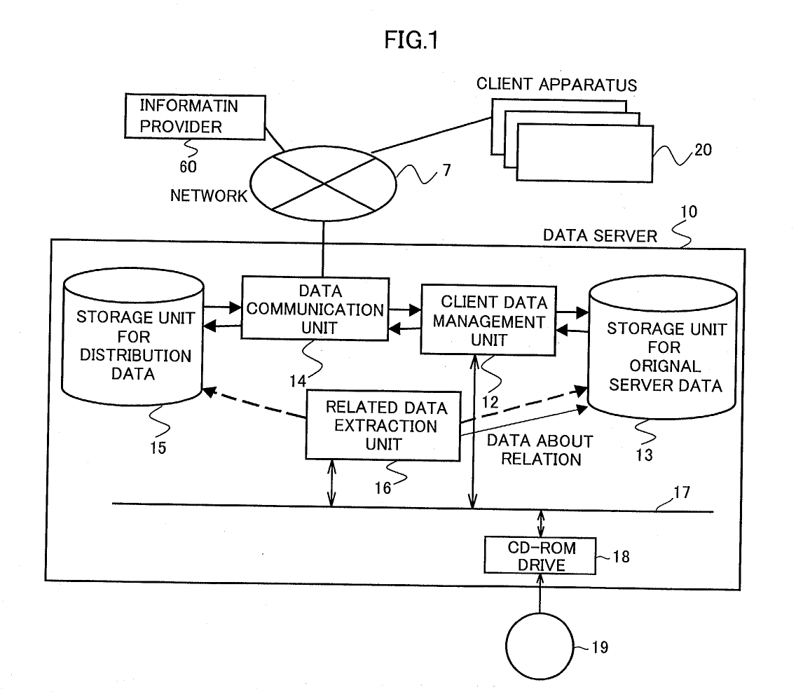

FIG. 1 is a function block diagram showing a structure of a data server in a first embodiment of the invention. Referring to FIG. 1, a data server 10 can perform communication with an information provider 60 and a client apparatus 20 via a network 7 such as the Internet.

Data server 10 includes a client data management unit 12 for managing data stored in each client apparatus 20, a storage unit 13 for storing original server data of each client apparatus 20, a storage unit 15 for storing distribution data sent from an information provider (which may be simply referred to as an “IP” hereinafter), a related data extraction unit 16 for extracting distribution data related to the data, which is stored in server data storage unit 13 and will be referred to as the “server data” hereinafter, a data communication unit 14 which is connected to network 7 for communication with each client apparatuses 20 and information provider 60, a CD-ROM (Compact Disc-Read Only Memory) drive 18 for reading a program controlling operations of data server 10 from a CD-ROM 19, and a data bus 17 for transmitting program data, which is read from CD-ROM drive 18, to client data management unit 12 and related data extraction unit 16.

The medium, which stores the program for controlling data server 10, is not necessarily restricted to CD-ROM 19. The medium may be a floppy disc, a DVD-ROM (Digital Versatile Disc-Read Only Memory) or the like, in which case a drive capable of reading a program from the medium is employed instead of CD-ROM drive 18. Further, the program may be stored in advance in a memory arranged within data server 10.

Client data management unit 12 has a function of performing, e.g., synchronizing processing for managing a state of matching between the data held in client apparatus 20 and the server data stored in server data storage unit 13, and checks, for example, whether data in each client apparatus 20 was changed or not. Client data management unit 12 partially or entirely copies the data stored in client apparatus 20 to server data storage unit 13 in accordance with a predetermined algorithm.

The data stored in client apparatus 20 may be any kind of data such as schedule data, PIM (Personal Information Manager) data such as an address list, memo and/or text data.

Distribution data storage unit 15 stores the distribution data sent from information provider 60 or the like via network 7. The distribution data relates to information such as an advertisement of a company, discount information or sending information, and a company or an individual wishes to distribute such distribution data to the user. The distribution data may be information of pages in a web site carrying such information, or may be information providing a link thereto.

Related data extraction unit 16 extracts the distribution data, which is related to the server data, and will be simply referred to as “related data” hereinafter, from distribution data storage unit 15 in accordance with predetermined timing. The extraction processing will be described later in greater detail. The related data may contain electronic coupons.

The related data extracted by extraction unit 16 is distributed to target client apparatuses 20 from communication unit 14 over network 7. Electronic mails are used for distributing the related data because the distribution can be achieved simply and easily. However, the manner of distribution is not restricted to the e-mails, and any manner may be employed provided that it can send the data.

The related data thus extracted is stored in a predetermined region of server data storage unit 13. The related data and the server data are managed while establishing a correlation between them so that management of the related data can be appropriately performed, e.g., by distributing data attracting user's interests or by deleting data.

As described above data related to the server data is extracted and distributed from data server 10 so that only the data attracting the user's interests is efficiently sent to the users. This reduces a load on client apparatus 20. Further, increase in traffic load on network 7 can be prevented.

It has been described that only one data server 10 is employed. However, a plurality of data servers may be employed for sharing the functions and/or the client apparatuses to be managed. In an example of sharing the functions, a system may use a mail server apparatus for sending/receiving mails, a data server for managing server data and a distribution server for managing distribution data in a coordinated fashion. This facilitates implementation of functions and maintenance. In an example of sharing client apparatuses 20 to be managed, apparatuses 20 may be configured to hold divided parts of data if many users (client apparatuses 20) utilize the service. Thereby, storage regions and processing functions are dispersed so that the processing efficiency can be improved.

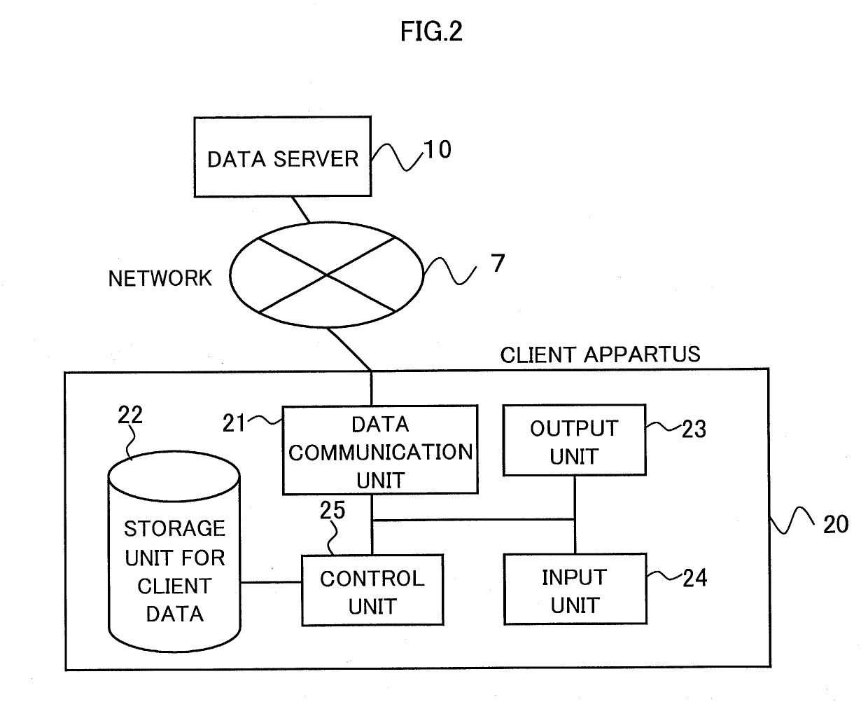

FIG. 2 is a function block diagram showing a structure of client apparatus 20 in the first embodiment of the invention. Client apparatus 20 includes a data communication unit 21 for performing communications with data server 10 via network 7, a storage unit 22 for storing the client data, an output unit 23 formed of a display for displaying character information and video information to the user as well as a loudspeaker or the like for outputting sounds and voices, an input unit 24 formed of a keyboard, buttons, camera, microphone and others, and a control unit 25 for controlling these units.

The program for operating control unit 25 of client apparatus 20 may be stored in advance in a memory arranged within client apparatus 20, or may be supplied by an appropriate device, which is provided for transferring the program from a medium such as a CD-ROM or a memory card carrying the program into a memory arranged within client apparatus 20.

Storage unit 22 for client data has already stored various data such as schedule data already described. For example, the user can enter schedule data or the like via input unit 24 so that the data thus entered is stored as client data in client data storage unit 22. Storage unit 22 may store data, which is externally sent over network 7.

The data sent from data server 10 is taken into client apparatus 20 via communication unit 21 and, for example, is displayed on output unit 23. The user can recognize useful related data, which is desired by the user, via output unit 23.

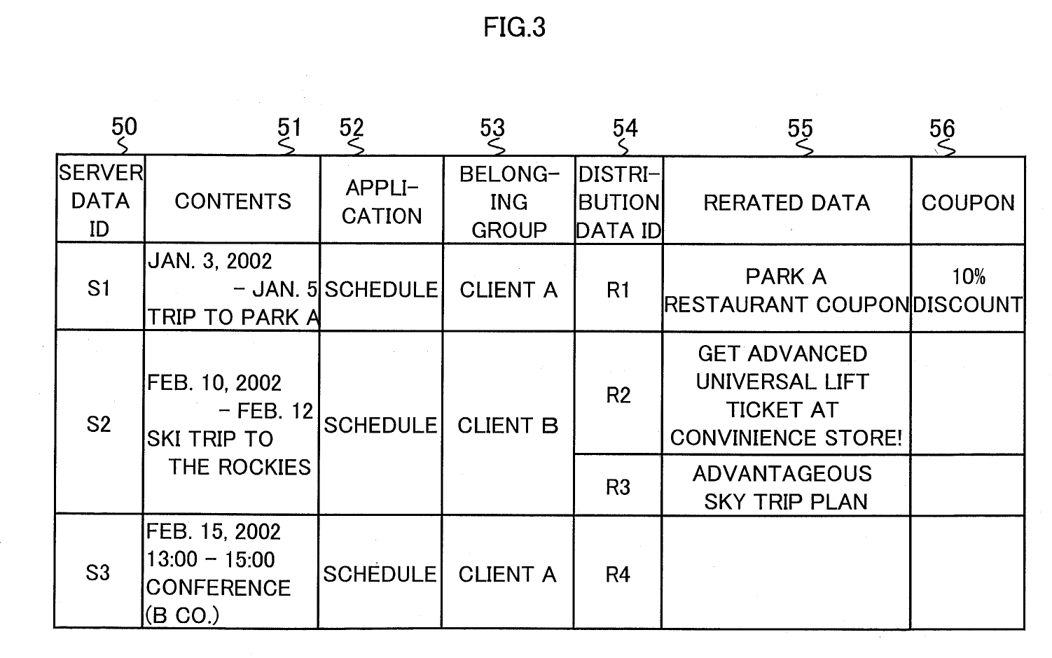

FIG. 3 represents an example of storage formats of the server data in server data storage unit 13. FIG. 3 shows a case where storage unit 13 for server data has stored copies of schedule data held in client apparatuses (terminals) A and B.

As represented in FIG. 3, storage unit 13 for server data has stored a server data ID 50, data contents 51, application 52, belonging group 53, distribution data ID 54, related data 55 and coupon 56.

Server data ID 50 is an identifier for identifying the server data, and is employed for the sake of management of data server 10. Data contents 51 are the client data itself, which is, e.g., entered and/or managed by the user in client apparatus 20, and may be referred to as “main data” hereinafter. Application 52 represents a type of the application handling the data in data server 10 and client apparatus 20, or represents a type of data.

Belonging group 53 means a group of the terminal, to which each server data belongs. This may represent one terminal as represented in FIG. 3, or may represent a plurality of terminals. If a plurality of terminals belong to certain server data, these terminals can share this server data.

Distribution data ID 54 is an identifier of the distribution data to be managed in data server 10. Related data 55 is related to the data contents, and is extracted from related data extraction unit 16. Coupon 56 is data, which is used when an electronic coupon is provided for the related data thus extracted.

In this example, the data contents (main data) are formed of schedule data. However, the data contents are not restricted to this, and may be an address list, memo, text data or the like.

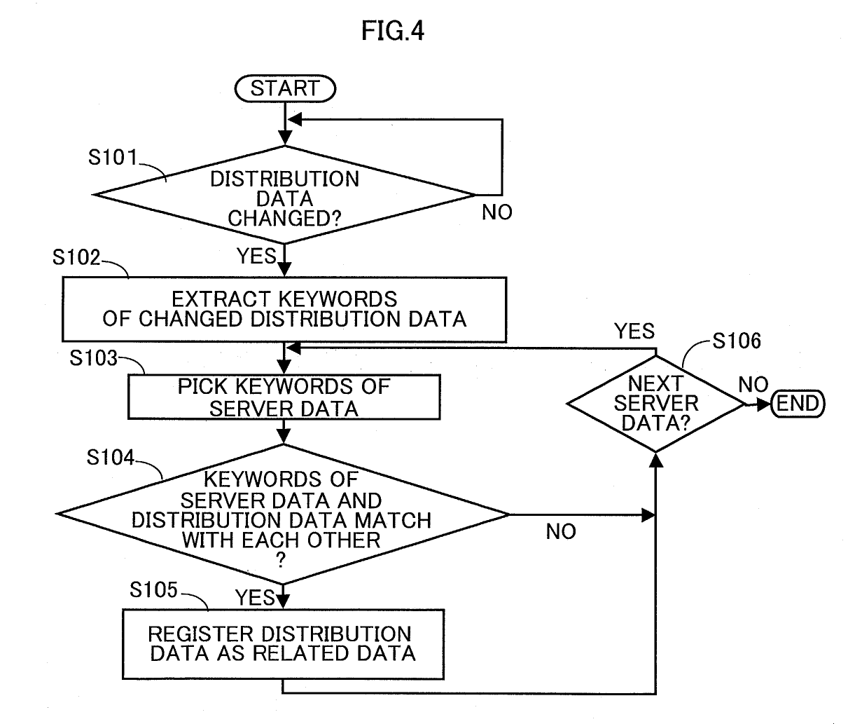

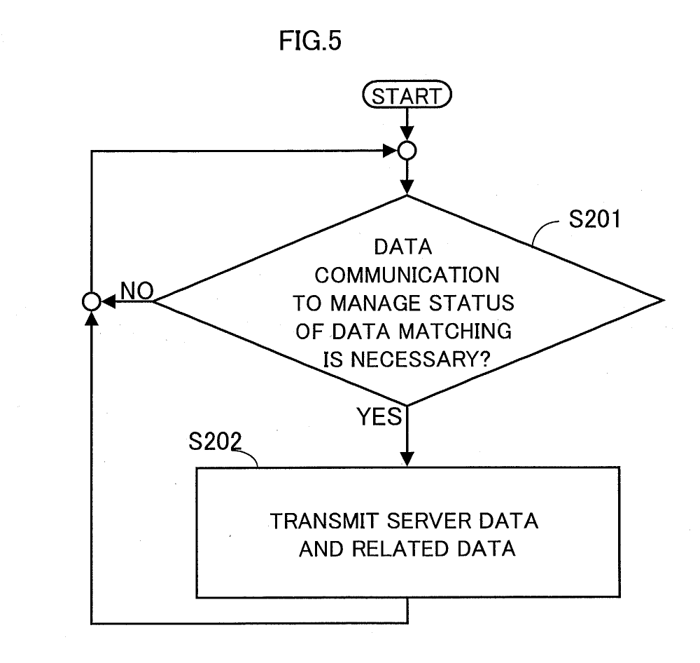

Description will now be given on a flow of whole operations of data server 10 with reference to FIGS. 4 and 5. FIG. 4 is a flowchart representing a flow of processing of extracting the distribution data (related data) related to the server data.

When the distribution data sent from information provider 60 is written into distribution data storage unit 15 (step S101), related data extraction unit 16 extracts a keyword(s) of changed distribution data (step S102), and extracts a keyword(s) of one data in the server data stored in server data storage unit 13 (step S103). It is determined whether any one of the extracted keyword(s) of the distribution data matches with keywords of the server data or not (step S104).

The keyword is usually a noun such as a destination or a person's name. One keyword may be extracted for one data item, or two or more keywords may be extracted for one data item. For example, as a keyword of the server data shown in FIG. 3, “PARK A” is extracted in relation to data contents of the server data ID of “S1”.

If the keyword of the distribution data matches with a keyword of the server data (“YES” in step S104), this distribution data is registered as the related data of the server data in server data storage unit 13 (step S105). More specifically, the distribution data and distribution data ID, which are related to each of the server data in server data storage unit 13, are registered while establishing a correlation between them. Only the related distribution data (related data) or only the distribution data ID may be registered.

When registration of the related data is completed, or when the keyword of the distribution data does not match with the keyword of the server data (“NO” in step S104), it is determined whether next server data is present or not (step S106). If the next server data is present, the processing returns to step S103, and a keyword for the next one data item in the server data is extracted. Then, processing before and in step S106 is repeated.

Processing in and between steps S103 and S106 is performed for all the server data, and the distribution data, which has been changed, is registered as the related data for each of the server data related to the distribution data thus changed.

In the example already described, extraction of the related data is performed in accordance with the same timing as the change of the distribution data. However, it may be performed in accordance with the same timing as updating of the server data, in which case related data extracting unit 16 retrieves the distribution data related to the updated server data in distribution data storage unit 15. Further, the related data can be extracted more reliably by performing the extraction when either of the distribution data and the server data is updated. In this case, the data related to the changed data is extracted.

Regardless of the extraction timing, such a manner may be employed that the related data for all the server data or all the distribution data is extracted. For preventing such a situation that notification of the same related data to the user is repeated, related data extraction unit 16 checks such repeating. For example, such a manner may be employed that the related data is extracted in connection with only the server data of the users, which were not targeted in the last processing, and such a manner may also be employed that all the server data are checked to determine whether the related data is already notified or not.

The extraction of related data may be performed at times other that times when the distribution data or the server data is updated, and may be performed periodically. In this case, the distribution data may be retrieved in connection with the server data, or conversely the server data may be retrieved in connection with the distribution data.

In the method of extracting the related data described above, the keyword is extracted from the data, and the keyword matching is performed using the extracted keyword. However, other methods may be performed. For example, matching may be performed between keywords or fields, which are set by information provider 60 and users in individual data thereof, respectively. Further, an associating method based on similarities of sentences may be employed.

FIG. 5 is a flowchart representing a flow of processing, which is performed when the related data is sent to client apparatus 20. Referring to FIG. 5, when data communication is necessary (“YES” in step S201) for managing a status of matching between the client data and the server data, data server 10 transmits the server data (main data stored as data contents 51 in FIG. 3) such as schedule data stored in server data storage unit 13 and the related data stored in relation to the server data (step S202).

The above situation, in which the communication is required for managing the matching state, occurs, e.g., when the data on the side of client apparatus 20 is changed, and thereby client data management unit 12 determines that the communication is required.

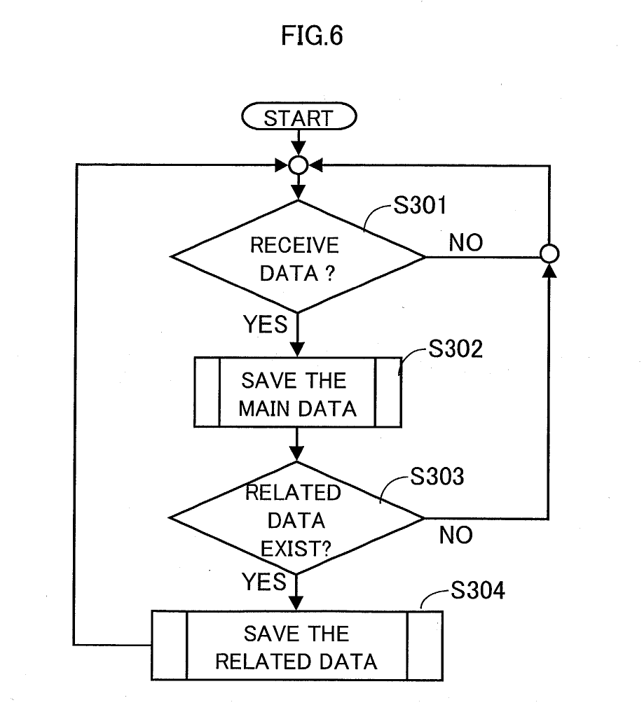

Description will now be given on processing in client apparatus 20 on the data receiving side. FIG. 6 is a flowchart representing a flow of whole operations of client apparatus 20 in this embodiment. Referring to FIG. 6, when communication unit 21 receives data (“YES” in step S301), processing of saving and managing the main data is performed (step S302). If there is a change in the main data, the data is stored in client data management unit 22.

If there is related data in the received data (“YES” in step S303), the related data is saved and managed (step S304). If there is a change in the related data, the related data is stored in client data storage unit 22. The related data may be saved and managed in relation to the main data, or may be saved and managed independently from the main data, in which case only the related data is output or appropriately handled.

Display and output of the related data may be performed, e.g., in such a manner that a list of the new related data is displayed when the user turns on the power of client apparatus 20, or that related data is displayed together with the main data. If there is coupon information, the coupon information is also displayed together with the related data.

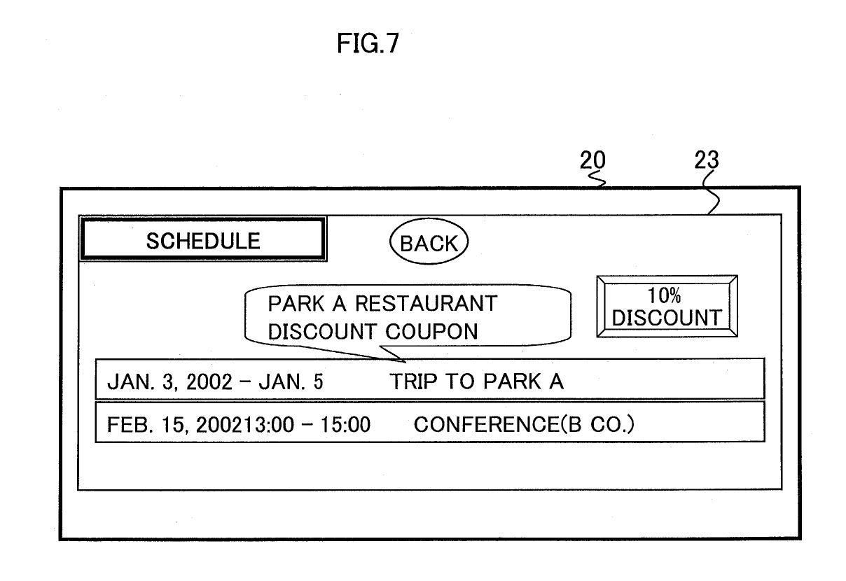

FIG. 7 shows an example, in which output unit 23 of client apparatus 20 displays the related data in addition to the main data. As shown in FIG. 7, related data “PARK A RESTAURANT DISCOUNT COUPON” and coupon information “10% DISCOUNT” are displayed in addition to the schedule data entered and managed by the user.

In this example, the related data is displayed within a balloon for reducing an influence on display of the original schedule data. However, the related data and others may be displayed within a list representing the schedule. If the coupon is added, the electronic coupon can be printed, and service or the like can be obtained by showing the printed coupon at a destination or ticket office. Alternatively, service or the like may be obtained by showing the coupon displayed on a screen of client apparatus 20, or by exchanging data of the electronic coupon between client apparatus 20 and a terminal on the service-provider side.

Further, the electronic coupon data may contain the electronic coupon ID, whereby unauthorized use of the electronic coupon can be prevented. For example, a unique coupon ID may be added to coupon 56 shown in FIG. 3 so that the coupon ID may be displayed when the coupon is displayed as shown in FIG. 7. The user can obtain the service only when the user gives the coupon ID together with the information such as the user's name registered in data server 10.

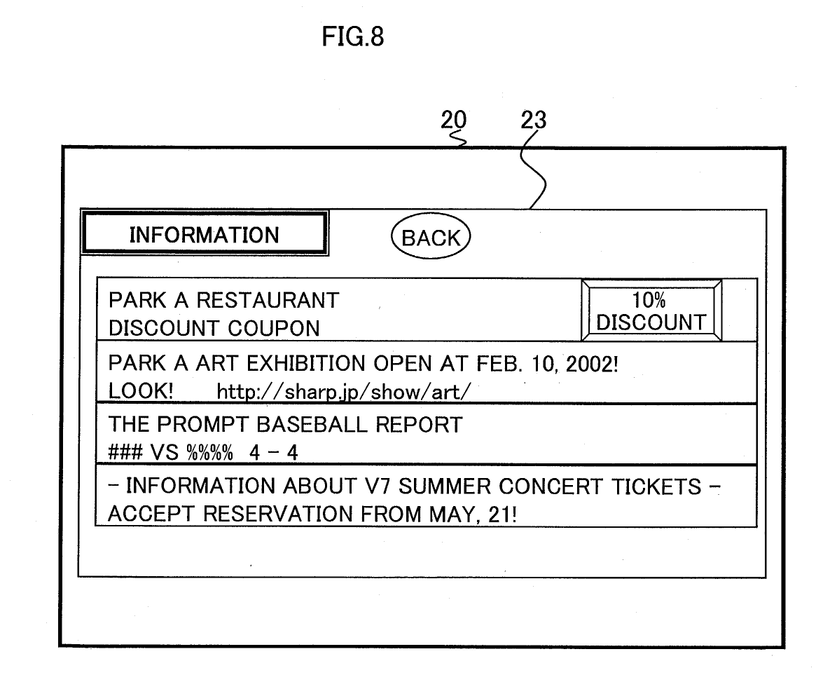

FIG. 8 shows an example, in which output unit 23 of client apparatus 20 displays only a list of the related data. In this case, when the user selects an item displayed as “INFORMATION” (special information), output unit 23 displays a list of the related data managed in client apparatus 20. By displaying the list of related data, the user can easily view the related data, which is related to the main data, and is not frequently viewed.

Not only the list of the related data, output unit 23 may display a list of new related data, which was received after the last display. Such a structure may also be employed that the user can designate the related information, of which display is desired by the user, and display of the related data thus designated is automatically updated when the related data having the updated contents is received. Thereby, the up-to-date information can be displayed without an operation of the user. For example, this is useful when displaying changes of a score in “professional baseball report”, as shown in FIG. 8.

[Second Embodiment]

A second embodiment of the invention will now be described.

A data server and a client apparatus in the second embodiment have substantially the same structures as data server 10 and client apparatus 20 in the first embodiment shown in FIGS. 1 and 2. However, the data server in the second embodiment is different from that in the first embodiment in that related data extraction unit 16 additionally has a function of selecting the client apparatuses of users, to which the related data is to be distributed. When information relating to the number of target users is added to the distribution data sent from information provider 60, this function of selecting the client apparatuses operates.

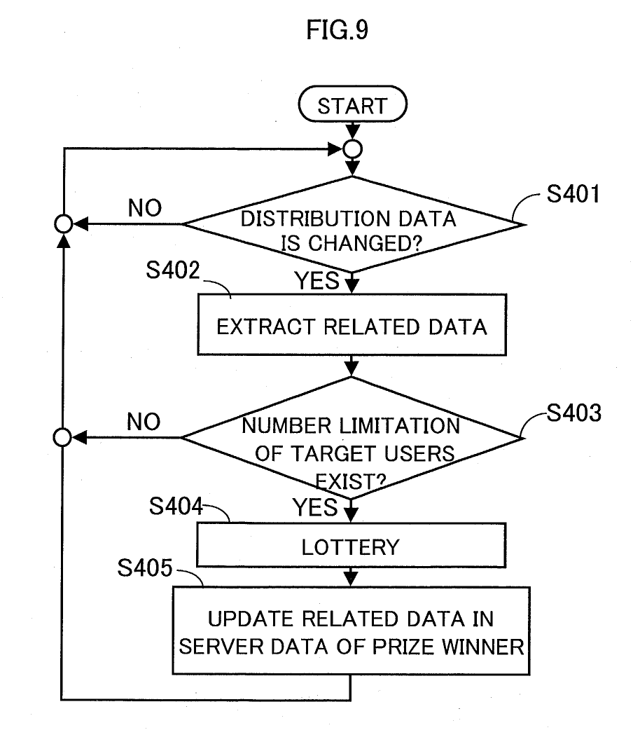

FIG. 9 is a flowchart representing a flow of whole processing of the data server in the second embodiment. In FIG. 9, processing in steps S401 and S402 is substantially the same as those in steps S101-S106 shown in FIG. 4, Thus, when the distribution data sent from information provider 60 is written into distribution data storage unit 15 (step S401), related data extraction unit 16 retrieves and extracts the related server data based on a predetermined algorithm from the server data stored in server data storage unit 13 (step S402). Thereby, several server data items are extracted for the changed distribution data.

When the number of target users is set in the changed distribution data (“YES” in step S403), lottery processing for selecting the target users (client apparatuses), to which the data is to be distributed, is performed (step S404). Thus, the lottery processing is performed by picking or selecting the client apparatuses equal in number to the target users based on the predetermined algorithm. The lottery processing can be performed when the distribution data, in which the number of target users is determined, is written in distribution data storage unit 13. Also, it may be performed in accordance with another timing. For example, a service provider may determine in advance a date of lottery, as is done, e.g., in a usual campaign carried out by giving a limited number of free presents, and the data server may be operated to perform the lottery on this date. If service is to be performed periodically, a period is determined in advance, and the lottery may be performed to select the users having the related data in the server data at determined periods so that the service can be performed in accordance with the user's schedule.

The related data for the client apparatus thus selected is updated (step S405). Thus, related data 55 (and distribution data Id and coupon 56) for the selected client apparatus, which is stored in server data storage unit 13, is updated to the changed distribution data.

In the second embodiment, as described above, the related data can be appropriately distributed even in the case where the number of target users receiving the related data is limited.

In the lottery processing (step S404), a predetermined number of client apparatuses are selected based on the client apparatuses. However, the selection can be performed based on the users. More specifically, if one user has two or more terminals, the information of belonging group 53 shown in FIG. 3 manages a correlation between the users and the terminals owned by the respective users. A predetermined number of users are selected from the users having the terminals, which have the server data related to the distribution data concerning with the lottery. Thereby, the lottery can be performed to select the distribution targets from the users.

If lottery conditions are attached to the distribution data sent from information provider 60 in addition to the number of target users, the processing of extracting the related data is performed in view of these conditions. This enables more reliable selection of the users, which are targeted on the service-provider side.

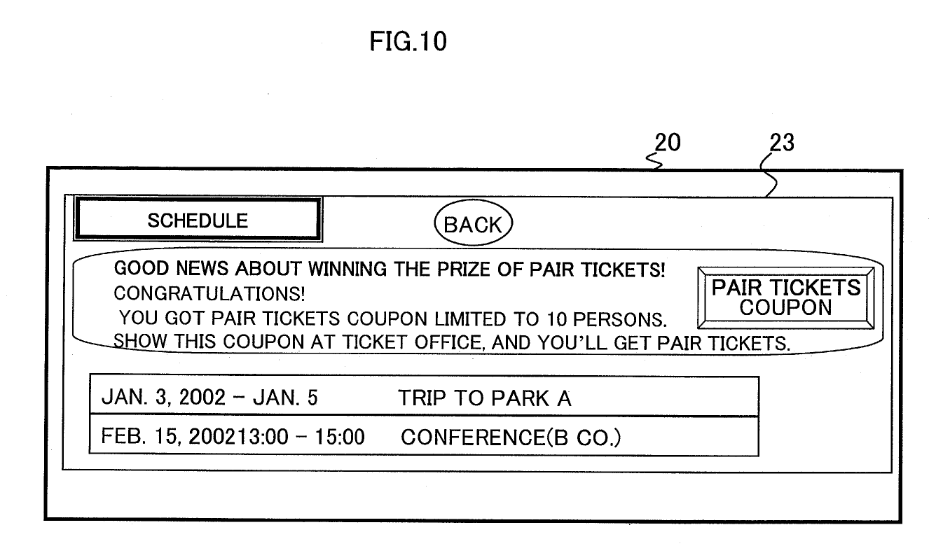

FIG. 10 shows an example of display on the client apparatus for notifying a result of a lottery. In FIG. 10, the client apparatus displays a notification of the result of lottery and an electronic coupon for service.

[Third Embodiment]

Description will now be given on a data server in a third embodiment.

The data server and the client apparatus in the third embodiment have substantially the same structures as data server 10 and client apparatus 20 in the first embodiment shown in FIGS. 1 and 2. However, the data server in the third embodiment has server data storage unit 13, which has additionally stored confirmation operation data.

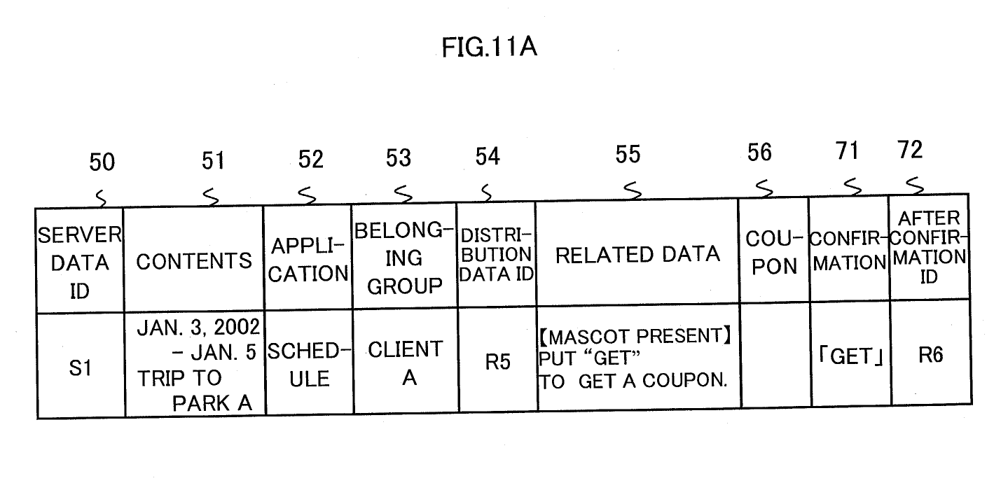

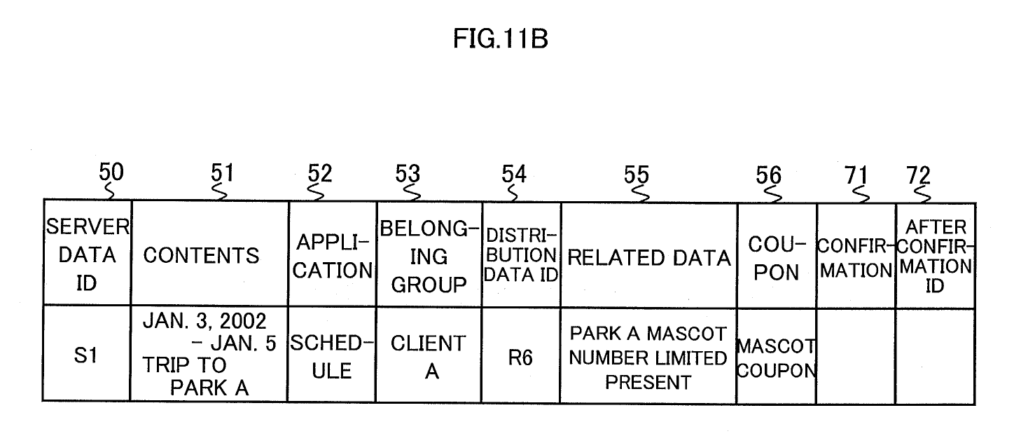

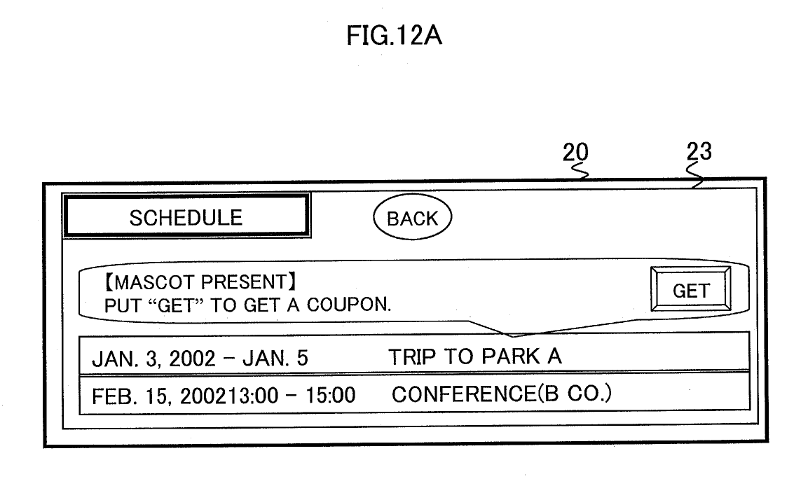

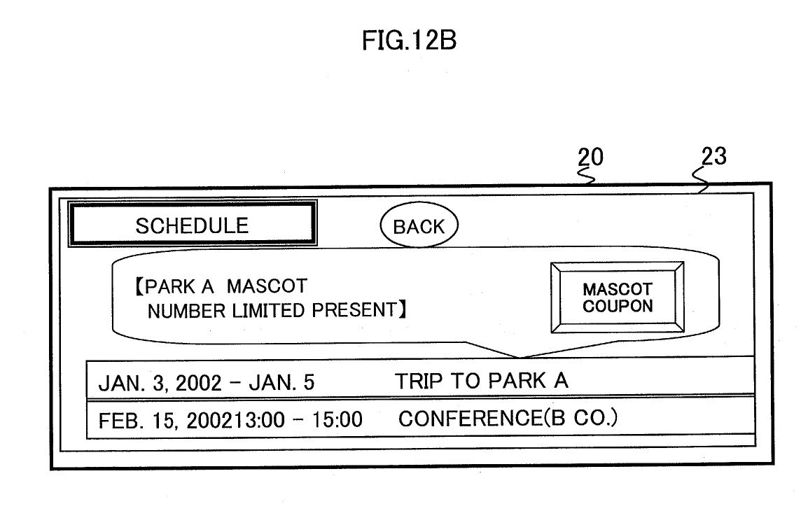

Referring to FIGS. 11A, 11B, 12A and 12B, description will now be given on the case where the user performs the confirmation operation. FIGS. 11A and 11B represent an example a storage format of the server data containing the confirmation operation data in server data storage unit 13. FIG. 11A represents an example of the distribution data used for providing guidance on service contents to the user. FIG. 11B represents an example of the distribution data of the actual service contents to be sent to the user who performed the confirmation operations.

As shown in FIG. 11A, storage unit 13 for server data stores server data ID 50, data contents 51, application 52, belonging group 53, distribution data ID54, related data 55 and coupon 56, and additionally stores confirmation operation 71 and after-confirmation ID 72.

The data item of confirmation operation 71 contain contents of the data, for which the user is requested to perform the confirmation, and after-confirmation ID 72 contains an identifier of the distribution data to be sent after the user performed the confirmation operation.

In the example of FIG. 11A, therefore, the data server sends the main data (schedule data) “TRIP TO PARK A”, the related data of the related service contents, confirmation operation data “GET” and distribution data ID “R5” to the client apparatus.

The client apparatus stores the related data in client data storage unit 22, similarly to the processing (step S304) represented in the flowchart in FIG. 6. At the same time, the confirmation operation data is operated. When displaying the related data, display is performed for urging the user to perform the confirmation operation.

FIGS. 12A and 12B show an example of display on output unit 23 of client apparatus 20 in the above case. More specifically, FIG. 12A shows an example of the display related to the confirmation operation in client apparatus 20, which received the guidance on the service contents, and FIG. 12B shows an example of display by client apparatus 20, which received the data of the actual service contents after performing the confirmation operation.

As shown in FIG. 12A, when client apparatus 20 receives the guidance on service contents from data server 10, client apparatus 20 displays the related data and the confirmation operation data “GET” button in a balloon. When the user operates the “GET” button, client apparatus 20 sends data of results of the confirmation operation to data server 10.

In the example described above, the button displayed on the screen is operated. However, the confirmation operation by the user is not restricted to it. The confirmation operation may be performed in various manners such as operations of buttons and/or switches on client apparatus 20, and may be generally performed in any manner allowing input via client apparatus 20. The data of results of the confirmation operation contains the data representing the fact that the user performed the confirmation operation, and also contains distribution data ID 54 (“R5” in this example).

When data server 10 receives the data of confirmation operation results corresponding to distribution data ID of R5 from client apparatus 20, client data management unit 12 refers to after-confirmation ID 72 (R6 in this example), and reads out the distribution data bearing the distribution data ID of R6 from distribution data storage unit 15. The contents of data related to the related data such as related data 55 are updated to the contents of distribution data ID of R6.

The contents (related data) of distribution data ID of R6 are the distribution data for the actual service contents. This data is sent from data server 10 to client apparatus 20 for display by client apparatus 20 when data communication is required for managing a status of data matching between the client data and the server data as already described in connection with step S201 in FIG. 5 showing the first embodiment.

As shown in FIG. 12B, when client apparatus 20 receives the data related to the actual service contents from data server 10, client apparatus 20 displays, e.g., the related data and data “MASCOT COUPON” of the coupon in a balloon.

Confirmation operation information 71 of the server data represented in FIGS. 11A and 11B may contain the attribute. In an example of the data represented in FIGS. 11A and 11B, data “[NAME PRINTED MASCOT PRESENT] INPUT NAME AND PUT “GET”, AND YOU WILL GET COUPON.”, i.e., the data which urges or recommends the input of attribute is stored as related data 55 of distribution data ID of R5.

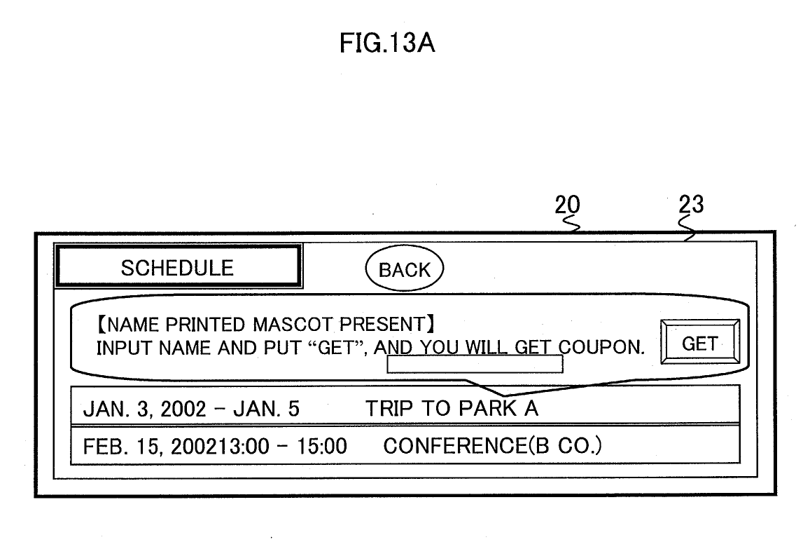

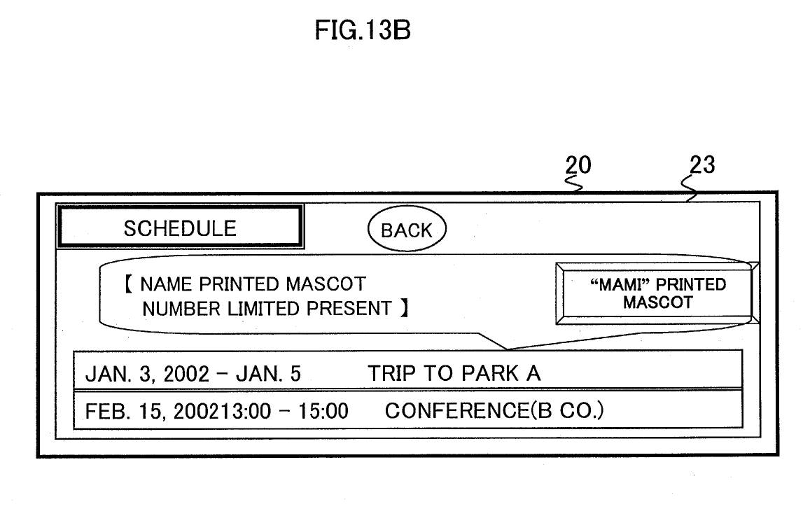

An example of the display by client apparatus 20 in the above case is shown in FIG. 13A. Client apparatus 20 displays the related data, the “GET” button and an attribute input area. When the user enter text into the attribute input area, and selects the “GET” button, information representing the selection of the “GET” button and text data are sent as the data of confirmation operation results to data server 10.

Data server 10 receiving the above data performs the after-confirmation operation described before, and sends the attribute data to information provider 60 and distribution data provider if necessary. Further, the attribute data may affect the distribution data of the actual service contents, which will be sent subsequently, so that the contents of the attribute data may be reflected in the display of related data 55 and coupon 56.

FIG. 13B shows an example of a notification of present contents, which is displayed by client apparatus 20 when the attribute data is reflected in the display of coupon. As shown in FIG. 13B, a user enters “MAMI” as the name of mascot, and the entered name is displayed on the coupon as ““MAMI” PRINTED MASCOT”.

By performing the confirmation operation processing as described above, the distribution data of the actual service contents can be sent only to client apparatuses 20, which have sent the results of confirmation operation.

<First Modification>

The user extracting processing already described in connection with the second embodiment may be combined with the above confirmation processing in the third embodiment. According to this combination, the processing for the limited number of service items can be appropriately processed only by writing the data distributed from information provider 60 into data server 10.

For example, if a user intends to reserve twenty tickets for a concert of V7 in advance, information provider 60 writes related data and a target user number of 20 in storage unit 13 for server data. Data server 10 performs lottery processing to pick twenty client apparatuses 20, and sends the related data containing the confirmation operation data to client apparatuses 20 thus picked.

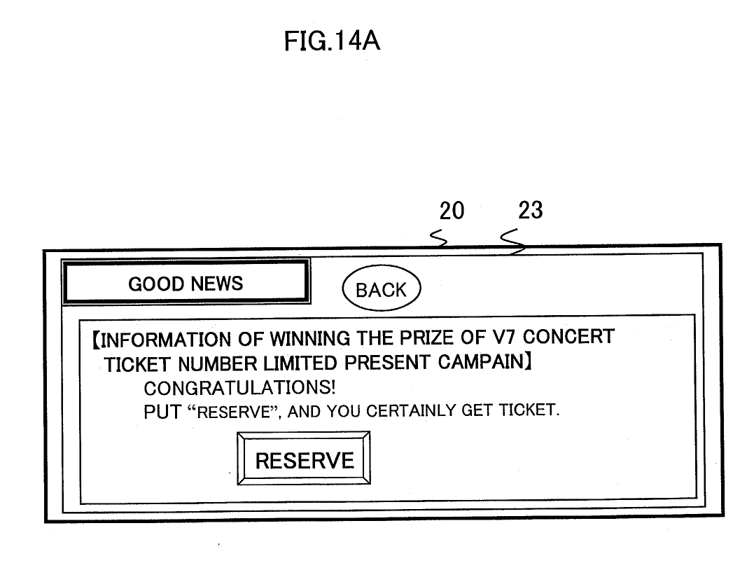

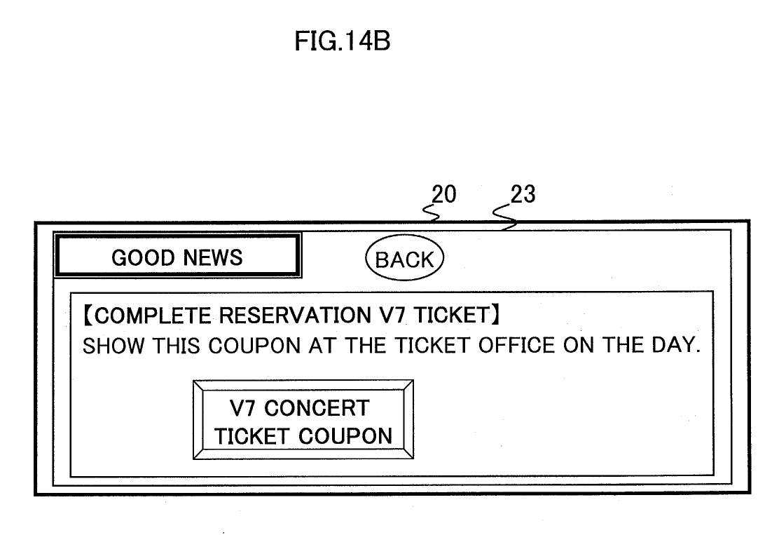

Client apparatus 20 displays the notification of results of the lottery together with the confirmation operation data. An example of such display is shown in FIG. 14A. When the user selects a “RESERVE” button, client apparatus 20 sends the results of confirmation operation to data server 10. Data server 10 sends the distribution data of the actual service contents accompanied with an electronic coupon to client apparatus 20, in which the confirmation operation was performed.

An example of display by client apparatus 20 receiving the above data is shown in FIG. 14B. As shown in FIG. 14B, client apparatus 20 displays the actual service contents, i.e., a notification of completion of the reservation and the electronic coupon. If one or some user(s) did not perform the confirmation operation and, for example, did not select the “RESERVE” button in FIG. 14A, the processing described above may be repeated until the number of users making the reservation reaches the number of target users.

<Second Modification>

In the data server of the invention, client data management unit 12 manages the correlation between the users and client apparatuses 20. Therefore, the data server can be applied to the cases where one user has two or more client apparatuses 20, or two or more users share one client apparatus 20. For example, client data management unit 12 has a lookup table for the users and client apparatuses 20, and thereby can manage them.

Further, the types of client apparatuses 20 (e.g., cellular phones, personal digital assistants (PDAs) and personal computers) can be managed depending on differences in processing performance, display capability or the like. Thereby, the manner, in which the related data is distributed, can be controlled. For example, short related data is sent to cellular phones, and related data accompanied with advertisements is sent to personal computers. By changing the distribution data in this manner, it is possible to output the related data suited to the performance of the client apparatus.

Related data extraction unit 16 of data server 10 may operate in view of the matters interested and registered by the users so that data server 10 can provide the distribution data matching with the user's interest to client apparatus 20. In advance, the user registers fields of interests and favorite matters in client apparatus 20, and sends such information to data server 10.

For example, it is assumed that “car” has been registered as a matter of interest. In the processing of extracting the related data of the schedule data concerning with a business trip to Tokyo, related data extraction unit 16 extracts data related to the car from the data, which is related to events in and near Tokyo, and is stored in distribution data storage unit 15. Thereby, it is possible to provide only the data in a narrowed range matching with the user's interest rather than all the data concerning with the events in and near Tokyo.

The following manner may be employed for designating the interests of the user. The data, for which the user wishes to receive the related data, is selected from the client data such as user's schedule. In the example of display by client apparatus 20 shown in FIG. 7, only the data “PARK A RESTAURANT” in the first line is selected as the matter of interest. Client apparatus 20 displays this selected information in a special manner such as a highlighting manner, and notifies it to data server 10.

In data server 10, when related data extraction unit 16 performs the extraction of the related data, it extracts the related data concerning with the server data “PARK A RESTAURANT” selected as the matter of interest. However, extraction in connection with “CONFERENCE (B CO.)” is not performed. The results are sent to client apparatus 20 so that the related data concerning with only for the user's interests is provided, and it is possible to prevent display of unnecessary distribution data.

As another manner, such a manner may be employed that the user selects a keyword and a field, or that automatic extraction is performed from information viewed by the user.

<Third Modification>

Description will now be given on the case where a user designated prohibition of reference to data from the distribution server.

The prohibition of reference to data may be selectively designated on a data-by-data basis, and may also be selectively designated for each category (application) or each of other attributes (belonging groups or attributes used in the application). Further, the prohibition can be designated for all the data of the user.

When the designation is to be made on a data-by-data basis, the designation is performed via a main data input screen or a change screen provided on client apparatus 20.

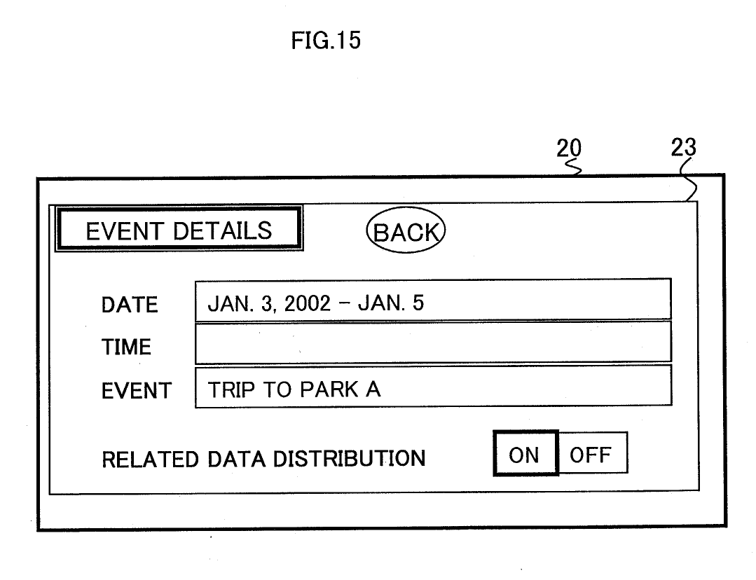

FIG. 15 shows an example of an input screen for main data of schedule. In this example, the user enters, as the main data, a date and time as well as schedule contents, and determines ON/OFF (i.e., necessity or nonnecessity) of the related data distribution service.

In defaults, ON is selected, and the user can select OFF only when such distribution service is not necessary so that it is not necessary to perform such a selecting operation at every time of input operation. When the designation is to be performed for each category, each attribute or all the data, the designation operation is performed through a setting screen provided for the related data on the client apparatus.

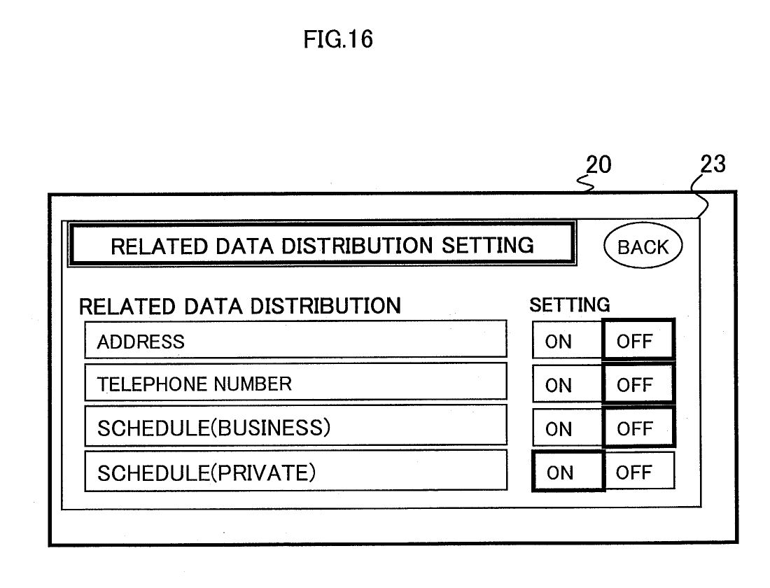

FIG. 16 shows an example for setting the related data distribution service. In this example, the user operates buttons for selecting ON/OFF for each of the categories of data, attributes and others.

Information for prohibiting the reference is sent from client apparatus 20 to data server 10, and is stored in the server data storage unit.

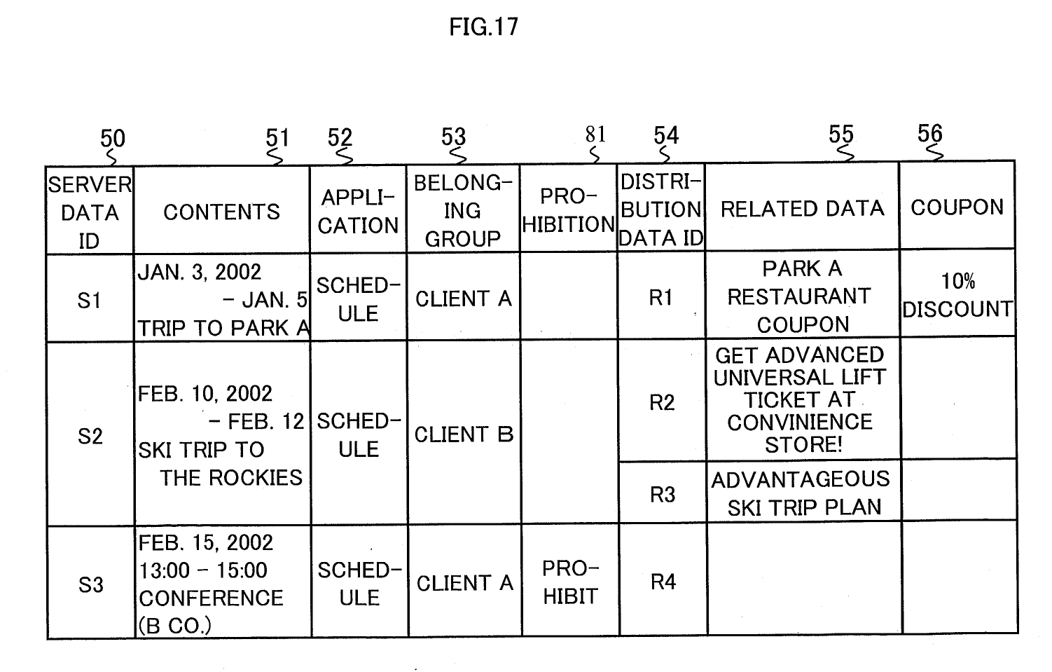

FIG. 17 shows an example of a storage format of the server data in the case where the information of reference prohibition for each data is saved.

The information for prohibiting or allowing the reference is saved together with the server data on a data-by-data unit. If the ON/OFF selection is to be performed for each category or for each attribute, the information representing prohibition or allowance of the reference is saved for each category or each attribute as data for the related data distribution service, independently of individual server data. When the ON/OFF is set for all the data, the information is similarly saved for each client apparatus or each user as the data for main service.

When the related data extraction unit extracts the related data, reference is not made to server data, to which reference is prohibited, and the related data is extracted only from the server data, to which reference is not prohibited. Thereby, such a situation is prevented that the distribution data concerning with the reference-prohibited server data is distributed to client apparatus 20.

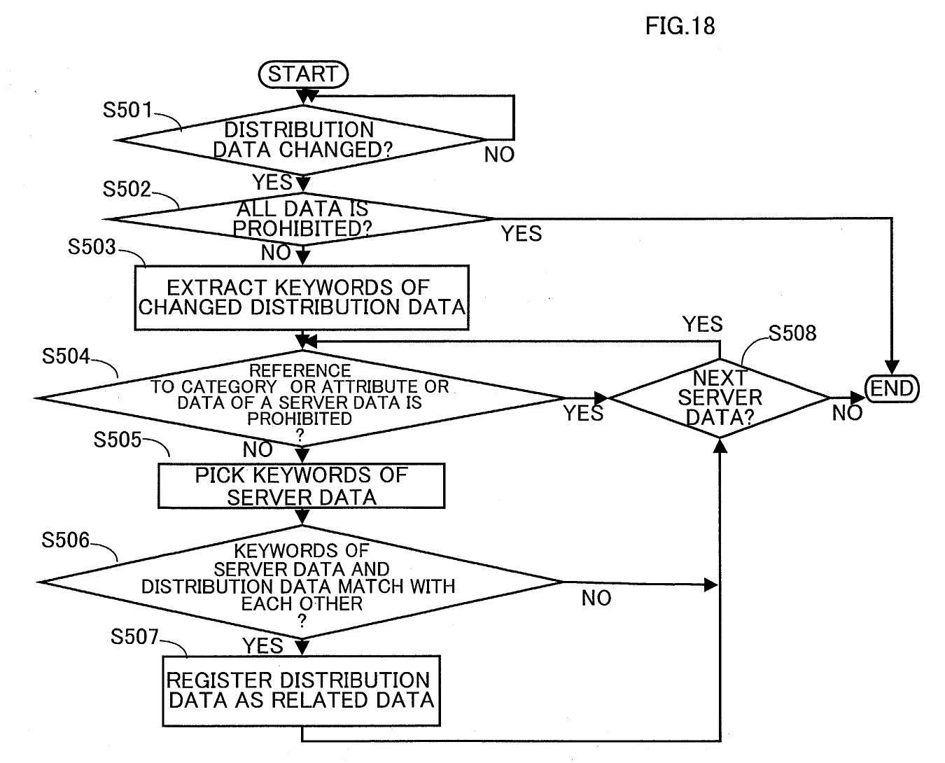

FIG. 18 is a flowchart representing a flow of extraction processing in the case where the prohibition or allowance of the reference is determined.

Referring to FIG. 18, when the distribution data provided by information provider 60 is written into storage unit 15 for distribution data (step S501), it is determined whether the target client apparatus or the target user has selected the prohibition of the data reference for all the data (step S502). If not selected, keyword selection in a step S503 is performed similarly to step S103 in FIG. 4. If selected, the processing ends.

After the keyword extraction in step S503, it is determined whether reference to the category, attribute or data of one server data is prohibited or not (step S504).

If not prohibited, processing in steps S505, S506 and S507 is performed similarly to steps S103, S104 and S105 in FIG. 4. In step S504, if reference to the category, attribute or data of one server data is prohibited, processing is performed for next server data (step S508).

<Fourth Modification>

A user can designate a time period or zone, in which the user wishes or does not wish the distribution of the related data, in client apparatus 20. For example, the client data is always required to be managed in connection with the server data in the data server. For the client data, therefore, the entire time zone is designated as the desired distribution time zone. For the related data, such a time zone is designated in view of a telephone charge system that allows distribution from the data server at low telephone charges.

When this information designating the time zone is sent from client apparatus 20 to data server 10, data server 10 receives this information, and distributes the related data in accordance with this time zone designation information. In this distributing operation, client data management unit 12 makes a selection between a manner of sending the main data and related data of the server data to client apparatus 20 and a manner of sending only the main data thereto. Thereby, ON/OFF of the distribution can be achieved.

Without using the instrument from client apparatus 20, data server 10 may be configured to obtain the data of the telephone charge system over network 7 for automatically setting the time zone. Further, client apparatuses 20, which use the same communication system, can be uniformly set by a manager or administrator so that these client apparatuses 20 can receive the distributed data at low and uniform charges.

<Fifth Modification>

Description will now be given on the case where a validity period is set in the distribution data. The validity period set in the distribution data can prevent such a disadvantage or problem that client apparatus 20 saves or displays the related data, which is already meaningless due to expiration of the validity period. For example, it is assumed that the distribution data, in which discount service period is set, is sent to client apparatus 20. Client apparatus 20 saves the data and displays the related data only for this service period. When the service period expires, the related data is deleted or appropriately processed, and is no longer displayed.

Data server 10 may be configured to manage the validity period of the distribution data within server data storage unit 13 and distribution data storage unit 15. In each of storage units 13 and 15, the data having the expired validity period is deleted or appropriately processed so that it is possible to avoid the meaningless processing or the like due to existence of the data having an expired validity period. Such a function may be employed that the user can instruct deletion of the data regardless of presence and absence of the validity period, if the user does not need the distribution data after viewing it. Thereby, it is possible to leave only the distribution data, which is necessary for the user. This function can be achieved in an easy-to-use manner, e.g., by displaying a “DELETE” button together with display of the related data.

<Sixth Modification>

Description will now be given on the case where a user designates or selects display and non-display of the related data, stop and start of the distribution of the related data from data server 20, and others. The designation for the above matters is performed via a screen provided in client apparatus 20 for setting in connection with the related data. The information for designating the stop or start of the distribution is sent from client apparatus 20 to data server 10, and client data management unit 12 controls the distribution timing of the related data based on the information thus sent. Thereby, an intention of the user concerning with the distribution timing of the related data is appropriately reflected.

<Seventh Modification>

Description will now be given on the case where data server 10 provides the distribution data as well as the related user information and others to the distribution data provider (information provider 60 or the like). First, related data extraction unit 16 extracts the server data related to the distribution data so that the users related to the distribution data are specified. The user interest information, age group information and other information concerning with the users, which are specified in this manner, as well as user data or the like provided from the related server data are provided to the distribution data provider such as information provider 60 over network 7.

More specifically, in the example of the server data shown in FIG. 3, data server 10 provides the information of an age, gender, residence and others of the user, who is a prospective visitor of A park, to the distribution data provider. Thereby, the distribution data provider can collect market information.

Further, data server 10 can provide a total of user data and statistical data based on age groups. Further, it is possible to conceal personal information of the user, if necessary. For example, data server 10 may be configured to conceal automatically the personal contents such as a name and a telephone number, or may be configured to conceal the data designated by the user or the data of the type (e.g., an address, telephone number, personal name, photograph and/or movie) designated by the user. The user can perform such designation via a main data input screen of client apparatus 20 or a screen for setting attributes of the main data.

By providing the user information including the results of lottery and the results of confirmation operation to the distribution data provider, the distribution data provider can utilize the information thus provided when performing the actual service. The above user information can be utilized for the inquiry about the foregoing electronic coupon ID and the name, and can also be utilized when an article is directly sent via the postal mail or courier service instead of providing the service via electronic communication.

In the embodiments described above, related data 55, coupon data 56 and confirmation operation data 71 are handled as data in the text format. However, it is possible to use a page description language such as HTML (Hypertext Markup Language) or XML (Extensible Markup Language), or a user interface description language, which can be interpreted by the client apparatus, so that a display format desired by the service user can be achieved.

The manner of outputting the related data is not restricted to the display of text on a screen, but may be selected, e.g., from audio output, image display or animation display depending on the output performance of client apparatus 20 provided that the user can recognize the output.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data server comprising:
an obtaining unit for obtaining predetermined data stored in a client apparatus,
a first storage unit for storing said predetermined data obtained by said obtaining unit and information of the client apparatus utilizing said predetermined data while establishing a correlation between said predetermined data and said information of the client apparatus;
a second storage unit for storing distribution data;
an extraction unit for extracting the distribution data related to the predetermined data stored in said first storage unit from said second storage unit; and
a distributing unit for distributing said extracted distribution data to the client apparatus utilizing said predetermined data.

2. The data server according to claim 1, further comprising:
a registering unit for registering said extracted distribution data in said first storage unit while establishing a correlation with said predetermined data.

3. The data server according to claim 1, wherein
said distribution unit sends information allowing specification of said predetermined data related to said extracted distribution data when distributing said extracted distribution data.

4. The data server according to claim 1, further comprising:
a management unit for managing client data stored in the client apparatus storing said predetermined data, wherein
said management unit sends the predetermined data already updated and said extracted distribution data to the client apparatus utilizing said predetermined data when the predetermined data stored said first storage unit is updated.

5. The data server according to claim 1, wherein
said management unit further manages a correlation between the client apparatus and a user.

6. The data server according to claim 1, wherein
said distribution unit distributes said extracted distribution data by means of an electronic mail.

7. The data server according to claim 1, wherein
the distribution data extracted by said extraction unit includes an electronic coupon.

8. The data server according to claim 1, further comprising:
a selecting unit for selecting the client apparatus as a target receiver of the distribution data extracted by said extraction unit, wherein
said distribution unit distributes said extracted distribution data to said selected client apparatus.

9. The data server according to claim 1, wherein
said distribution unit distributes said distribution data together with confirmation operation information for confirming a service; and
said data server further comprises:
a receiver unit for receiving results of the confirmation operation from the client apparatus receiving said confirmation operation information, and
a providing unit for providing a service in accordance with said received confirmation operation results.

10. The data server according to claim 9, wherein
said received confirmation operation results include attribute information.

11. The data server according to claim 1, further comprising:
an obtaining unit for obtaining information related to matters of user's interest, wherein
said extraction unit narrows an extraction range of the distribution data based on said obtained matters of user's interest.

12. The data server according to claim 1, wherein
a receiving unit for receiving reference prohibition information sent from said client apparatus, wherein
said extraction unit stops extraction of said distribution data related to said predetermined data in accordance with said reference prohibition information.

13. A data distribution program product for operating a computer to execute:
an obtaining step of obtaining predetermined data stored in a client apparatus;
a first storage step of storing said predetermined data obtained in said step and information of the client apparatus utilizing the predetermined data while establishing a correlation between the data and the information;
a second storage step of storing distribution data;
an extraction step of extracting the distribution data related to the predetermined data stored in said first storage unit from said second storage unit; and
a distribution step of distributing said extracted distribution data to the client apparatus utilizing said predetermined data.

14. A computer-readable record medium for storing a data distribution program for operating a computer to execute:
an obtaining step of obtaining predetermined data stored in a client apparatus;
a first storage step of storing said predetermined data obtained in said step and information of the client apparatus utilizing the predetermined data while establishing a correlation between the data and the information;
a second storage step of storing distribution data;
an extraction step of extracting the distribution data related to the predetermined data stored in said first storage unit from said second storage unit; and
a distribution step of distributing said extracted distribution data to the client apparatus utilizing said predetermined data.

15. A client apparatus comprising:
a storage unit for storing predetermined data to be managed in a data server;
a receiving unit for receiving the data from said data server;
an updating unit for updating the data in said storage unit to updated data when said received data includes said updated data for said predetermined data;
a registering unit for registering related data related to said predetermined data already stored or updated in said storage unit when said received data includes said related data; and
a recognizing unit for achieving recognition of the related data registered in said registering unit by a user.
